(19) United States
(12) Patent Application Publication
(10) Pub. No.: US 2019/0076872 A1
(43) Pub. Date: Mar. 14, 2019

(54) CAULKING GUN

(71) Applicant: Steve Filipovic, Strathmore, Victoria (AU)

(72) Inventor: Steve Filipovic, Strathmore, Victoria (AU)

(21) Appl. No.: 16/070,219

(22) PCT Filed: Jan. 16, 2017
(86) PCT No.: PCT/AU2017/000007

§ 371 Date: Jul. 13, 2018

(30) Foreign Application Priority Data
Jan. 14, 2016 (AU) 2016900111

(51) Int. Cl. B05C 17/01; B05B 15/63

(52) U.S. Cl. CPC B05C 17/0123; B05C 17/0052; B05B 15/63

(57) ABSTRACT

The present invention provides a caulking gun comprising a cartridge holder comprising an elongate body portion for receiving a tubular cartridge of fill material, said elongate body portion comprising at least one magnetic portion, a handle grip comprising controls for operating a plunger and a piston which pushes on a bottom end of the cartridge to expel a bead of the fill material out from the tip of a nozzle on a top end of the cartridge and wherein the caulking gun is removeably attachable to a suitable support via the at least one magnetic portion.

### FIELD OF THE INVENTION

The present invention relates to caulking guns. In particular, but not exclusively, the present invention relates to caulking guns that utilise pre-filled cartridges of caulk, silicon, glue, sealant or fill material. However, it will be appreciated that the present invention has broader application and is not limited to that particular use.

### BACKGROUND TO THE INVENTION

Caulking guns are commonly used as a construction and repair tool to expel caulk, silicon, glue, sealant or other material with greater precision than would be likely with trowels, putty knives or the like. Caulking guns usually have a tubular container for fill material held in a elongate body, with a gun-like handle grip containing controls for operating a piston which pushes on one end of the container to expel a bead of the material out the tip of a nozzle on the other end. Two general classes of caulking guns are distinguished largely by whether or not they operate using pre-filled, disposable cartridges with built-in nozzles or have fill material tubes integral with the gun. In either case, caulking guns may include pneumatic or hydraulic powered actions to apply pressure to the piston, but most are simple, mechanical devices with a ratcheted plunger that moves the piston in response to squeezing a lever on the hand grip. The present invention relates to caulking guns that utilise pre-filled, disposable cartridges.

Once the cartridge has been exhausted and must be replaced the user then retracts the piston, removes and stows the spent cartridge while reaching for a fresh cartridge which he inserts into the gun, all with one hand while he holds the gun with the other hand. This process can be quite fiddly, especially if the user must descend and re-ascend a ladder to retrieve a fresh cartridge and dispose of a spent one each time he empties a cartridge. Means for freeing a user's hand during cartridge changes would be welcome to most users.

During the use of a caulking gun upon a ladder, it is a safety hazard to lie said caulking gun upon a step or rung of said ladder when not in use as said caulking gun can readily fall from said step or rung and either injure the workers holding up the ladder, or working below. Additionally, the cartridge within the caulking gun can be destroyed by the fall of the caulking gun.

In this specification, the terms “comprises”, “comprising” or similar terms are intended to mean a non-exclusive inclusion, such that a caulking gun that comprises a list of elements does not include those elements solely, but may well include other elements not listed.

### OBJECT OF THE INVENTION

It is a preferred object of the present invention to provide a caulking gun, that addresses or at least ameliorates one or more of the aforementioned problems of the prior art and/or provides a consumer with a useful or commercial choice.

### SUMMARY OF THE INVENTION

Generally, embodiments of the present invention relate to a caulking gun which is removably attachable to a metal support when not in use.

According to one aspect, although not necessarily the broadest aspect, the present invention resides in a caulking gun comprising:

a cartridge holder comprising an elongate body portion for receiving a tubular cartridge of fill material, said elongate body portion comprising at least one magnetic portion;

a handle grip comprising controls for operating a plunger and a piston which pushes on a bottom end of the cartridge to expel a bead of the material out the tip of a nozzle on a top end of the cartridge; and

wherein the caulking gun is removeably attachable to a suitable support via the at least one magnetic portion.

Preferably, the body portion is not a closed cylinder, but partially surrounds its longitudinal axis with a sufficient opening in its circumference to admit the diameter of the cartridge.

Preferably, at either end of the body portion of the cartridge holder is an end cap wherein a first end cap is provided at a top end of the body portion and a second end cap is provided at a bottom end of the body portion.

Preferably, the first end cap includes an aperture which is adapted to receive and admit the nozzle of the cartridge.

Preferably, the second end cap is adapted to receive the plunger and the piston coupled thereto and has an aperture for receiving the plunger therethrough.

Preferably, the handle grip comprises a grip lever for urging the piston and plunger forward by repeated incremental steps induced by squeezing the grip lever against the handle grip in a scissor-like grasp.

Suitably, the caulking gun comprises a pair of magnetic portions disposed on the backbone of the caulking gun wherein one magnetic portion is positioned toward the top end of the body portion and another toward the bottom end of the body portion.

Preferably, each magnetic portion has a recess which is adapted to receive at least one magnetic insert therein such that, the at least one magnetic insert can be embedded within the face or body of the caulking gun.

Suitably, the magnetic inserts are in the form of circular magnets.

Preferably, the support to which the caulking gun is attachable is composed at least in part of magnetically attractive, usually ferrous material.

Suitably, the support can be a ladder, support beam, magnetically attractive portion of a tool belt or the like or any other suitable structure or material.

Further features and forms of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 shows a front side perspective view of a caulking gun according to an embodiment of the present invention;

FIG. 1A shows a front side perspective view of the caulking gun of FIG. 1 loaded with a pre-filled cartridge;

FIG. 2 shows a rear side perspective view of the caulking gun of FIG. 1 according to an embodiment of the present invention;

FIG. 2A shows a front side perspective view of the caulking gun of FIG. 1 attached to a support; and

FIG. 3 shows a rear side perspective view of the caulking gun of FIG. 1 depicting an alternate position for at least one magnetic portion of the caulking gun.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

Embodiments of the present invention will be described with reference to a caulking gun which is removably attachable to a metal support. For convenience sake, the caulking gun will be described herein as one that utilises pre-filled cartridges of caulk, silicon, glue, sealant or fill material. However, it should be appreciated that embodiments of the present invention can be modified to suit any other suitable caulking guns. It will be appreciated that variations may need to be made as required.

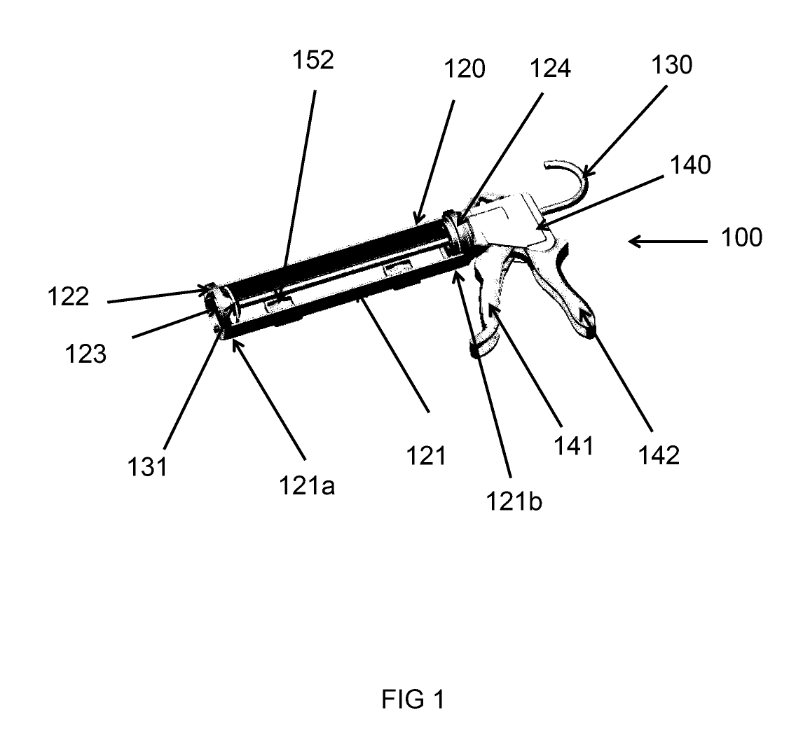

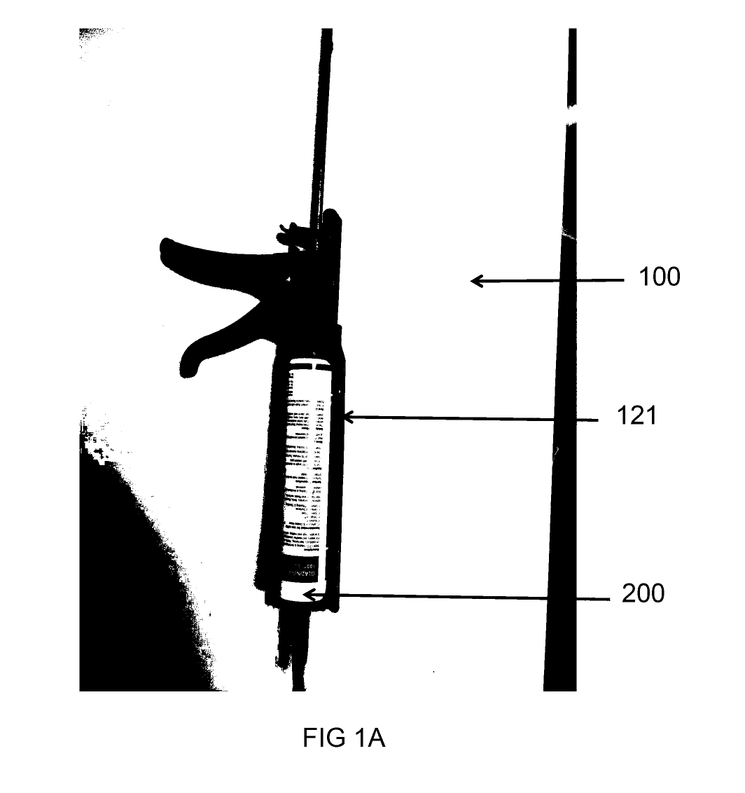

Referring to FIG. 1, the caulking gun 100 is provided in accordance with embodiments of the present invention. According to some embodiments, the caulking gun 100 is made of a metallic or plastic material. However, it is envisaged that any other suitable material may be utilised. The caulking gun 100 comprises a cartridge holder 120. The cartridge holder 120 comprises an elongate body portion 121 for receiving a tubular cartridge of fill material. Though substantially cylindrical, the body portion 121 is not a closed cylinder, but partially surrounds its longitudinal axis with a sufficient opening in its circumference to admit the diameter of a pre-filled cartridge 200, as illustrated in FIG. 1A.

At either end of the body portion 121 of the cartridge holder 120 is an end cap. A first end cap 122 is provided at a top end 121a of the body portion 121. The first end cap 122 includes an aperture 123 which is adapted to receive and admit a nozzle of the cartridge such that, when the filled cartridge is lying substantially coaxial with the body portion 121, the nozzle will protrude through the end cap 122. A second end cap 124 is provided at a bottom end 121b of the body portion 121. The second end cap 124 is adapted to receive a plunger 130 and piston 131 coupled thereto and has an aperture for receiving the plunger 130 therethrough. The rear end of the cartridge nests within the second end cap 124 and abuts against the piston 131 of the plunger 130. The piston 131 has a diameter slightly smaller than and rests within a recess provided on the rear end of the cartridge typically provided for the purpose and commonly known in the art. The piston 131 is adapted to apply axial pressure to urge fill material out of cartridge through the nozzle.

The caulking gun 100 comprises a hand grip 140 comprising controls for operating the piston 131 and plunger 130 which pushes on the rear end of the cartridge to expel a bead of the material out from the tip of the nozzle on the other end of the cartridge. The piston 131 and plunger 130 is urged forward by repeated incremental steps induced by squeezing a grip lever 141 against the handle grip 142 in a scissor-like grasp adapted to keep steady pressure on the fill material in cartridge as it is emptied by usage. Release of the grip lever 141 permits retraction of the piston 131 and plunger 130 when the cartridge is exhausted and needs replacing with a fresh cartridge, as is commonly known in the prior art.

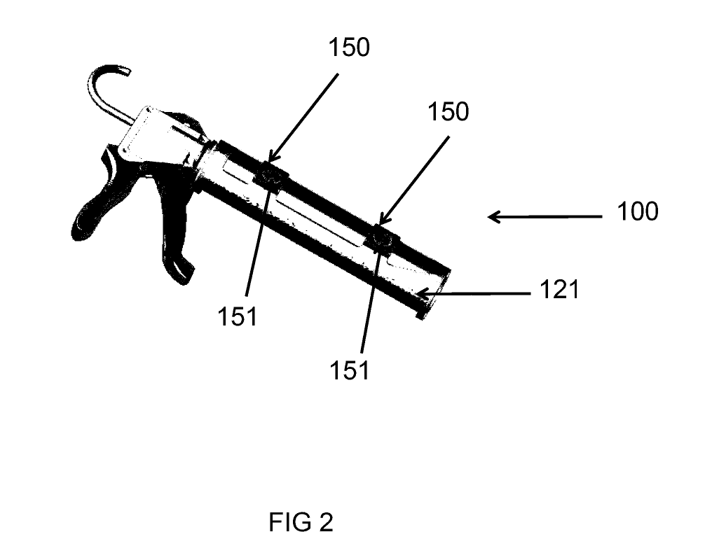

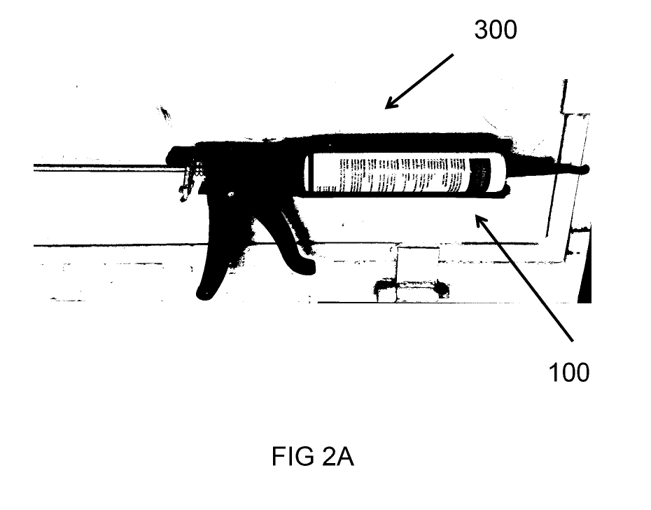

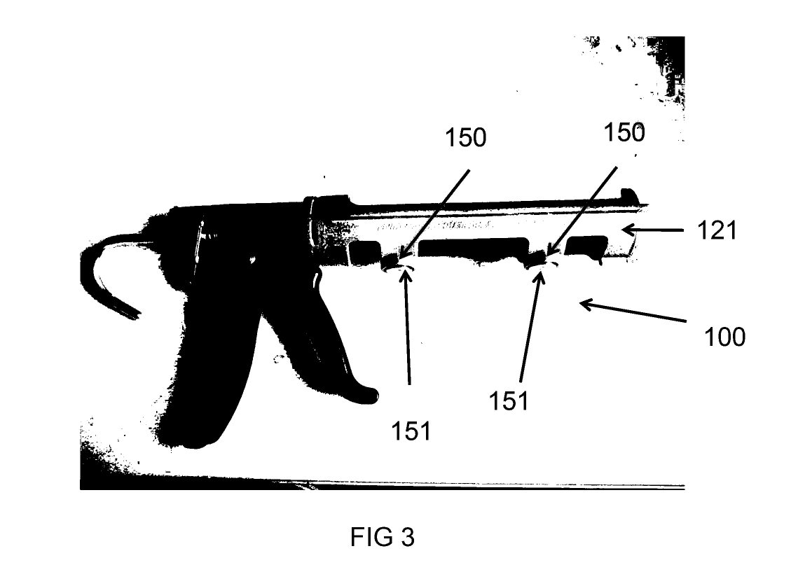

Referring to FIGS. 2 and 3, the caulking gun 100 comprises at least one magnetic portion 150 to enable the caulking gun to be magnetically attachable to a suitable support 300 to provide a means for keeping the caulking gun stored and handy to a user when not in use. FIG. 2A illustrates the caulking gun 100 attached to a support 300. According to a preferred embodiment illustrated in FIG. 2, the caulking gun comprises a pair of magnetic portions 150 disposed on the backbone of the caulking gun 100 wherein one magnetic portion 150 is positioned toward the top end 121a of the body portion 121 and another toward the bottom end 121b of the body portion 121. The magnetic portions 150 are evenly spaced apart to ensure the caulking gun 100 has full capacity to fasten itself magnetically to the suitable support and have the optimal connection thereto. In an alternative embodiment, it is envisaged that the number and positioning of the magnetic portions 150 may be varied as desired.

Each magnetic portion 150 has a recess 152 (as shown in FIG. 1) which is adapted to receive at least one magnetic insert 151 therein such that, the at least one magnetic insert 151 can be embedded within the face or body of the caulking gun 100. The at least one magnetic insert 151 can be secured within the recess via any suitable means such as adhesive or the like. The magnetic inserts 151 are preferably in the form of circular magnets. The magnets 151 are 12 mm in diameter and weigh approximately five hundred grams. In alternative embodiments, it will be acknowledged that the size, shape, weight and strength of the magnets/magnetic inserts can be varied as desired.

The support 300 to which the caulking gun 100 is attachable is composed at least in part of magnetically attractive, usually ferrous material. It may be composed entirely of ferrous metals such as steel. Accordingly, the support 300 can be a steel ladder, support beam, magnetically attractive portion of a tool belt or the like or any other suitable structure or material in close vicinity to where the user is working. The support could also be a specially designed support for storing the caulking gun when not required.

Hence, the caulking gun of the present invention provides a solution to the aforementioned problems of the prior art by providing a caulking gun which is magnetically attachable to a suitable support to provide a means for keeping the caulking gun handy to a user when not in use. The present invention is simple and inexpensive and may be readily attached to suitable support such as a ladder (not aluminium) or support beam, wherein the caulking gun can be maintained securely in place when not in use and easily removed when it is desired to use said caulking gun.

The reference to any prior art in this specification is and should not be taken as, an acknowledgment or any form or suggestion that the prior art forms part of the common general knowledge in any country.

Throughout the specification the aim has been to describe the invention without limiting the invention to any one embodiment or specific collection of features. Persons skilled in the relevant art may realize variations from the specific embodiments that will nonetheless fall within the scope of the invention.

I claim:

1. A caulking gun comprising:
a cartridge holder comprising an elongate body portion for receiving a tubular cartridge of fill material, said elongate body portion comprising at least one magnetic portion;
a handle grip comprising controls for operating a plunger and a piston which pushes on a bottom end of the cartridge to expel a bead of the fill material out from the tip of a nozzle on a top end of the cartridge; and
wherein the caulking gun is removeably attachable to a suitable support via the at least one magnetic portion.

2. The caulking gun of claim 1, wherein the body portion is not a closed cylinder, but partially surrounds its longitudinal axis with a sufficient opening in its circumference to admit the diameter of the cartridge.

3. The caulking gun of claim 1, wherein at either end of the body portion of the cartridge holder is an end cap wherein a first end cap is provided at a top end of the body portion and a second end cap is provided at a bottom end of the body portion.

4. The caulking gun of claim 3, wherein the first end cap includes an aperture which is adapted to receive and admit the nozzle of the cartridge.

5. The caulking gun of claim 3, wherein the second end cap is adapted to receive the plunger and the piston coupled thereto and has an aperture for receiving the plunger therethrough.

6. The caulking gun of claim 1, wherein the handle grip comprises a grip lever for urging the piston and plunger forward by repeated incremental steps induced by squeezing the grip lever against the handle grip in a scissor-like grasp.

7. The caulking gun of claim 1, wherein the caulking gun comprises a pair of magnetic portions disposed on the backbone of the caulking gun wherein one magnetic portion is positioned toward the top end of the body portion and another toward the bottom end of the body portion.

8. The caulking gun of claim 1, wherein each magnetic portion has a recess which is adapted to receive at least one magnetic insert therein such that, the at least one magnetic insert can be embedded within the face or body of the caulking gun.

9. The caulking gun of claim 8, wherein the magnetic inserts are in the form of circular magnets.

10. The caulking gun of claim 1, wherein the support to which the caulking gun is attachable is composed at least in part of magnetically attractive, usually ferrous material.

11. The caulking gun of claim 1, wherein the support can be a ladder, support beam, magnetically attractive portion of a tool belt or the like or any other suitable structure or material.
